(19) United States
(12) Patent Application Publication
(10) Pub. No.: US 2026/0302277 A1
(43) Pub. Date: Oct. 1, 2026

(54) FUEL CELL SYSTEM

(71) Applicant: HONDA MOTOR CO., LTD., TOKYO (JP)

(72) Inventor: Shun IZUMI, WAKO-SHI (JP)

(21) Appl. No.: 19/574,917

(22) Filed: Mar. 23, 2026

(30) Foreign Application Priority Data
Mar. 25, 2025 (JP) 2025-049250

(51) Int. Cl. H01M 8/04044; H01M 8/04029; H01M 8/04537; H01M 8/04746; H01M 8/10; H01M 8/1007

(52) U.S. Cl. CPC H01M 8/04044; H01M 8/04029; H01M 8/04634; H01M 8/04768; H01M 8/1007; H01M 2008/1095

(57) ABSTRACT

A fuel cell system includes: a plurality of fuel cell modules each including a fuel cell stack and a cooling device that cools the fuel cell stack; a coupled cooling circuit in which cooling circuits respectively included in the plurality of fuel cell modules are connected in parallel to one another; and an ion exchange device connected to the coupled cooling circuit and including a plurality of ion exchangers. A switching valve that selectively switches a flow of coolant to the plurality of ion exchangers allows the coolant to flow through only one of the plurality of ion exchangers.

### CROSS-REFERENCE TO RELATED APPLICATIONS

This application is based upon and claims the benefit of priority from Japanese Patent Application No. 2025-049250 filed on Mar. 25, 2025, the contents of which are incorporated herein by reference.

### BACKGROUND OF THE INVENTION

### Field of the Invention

The present disclosure relates to a fuel cell system.

### Description of the Related Art

In recent years, research and development have been conducted on fuel cell systems that contribute to energy efficiency in order to ensure that more people have access to affordable, reliable, sustainable and modern energy.

JP 2022-118947 A discloses a fuel cell system including a plurality of fuel cell modules and a coolant cooling device (a radiator), wherein each fuel cell module includes a fuel cell body, an ion remover (an ion exchanger), a pump, and a three way valve.

### SUMMARY OF THE INVENTION

Incidentally, in a fuel cell system including a plurality of fuel cell modules, an ion exchanger is provided for each fuel cell module. Therefore, the life of the plurality of ion exchangers may vary depending on the operating conditions of the fuel cell modules.

When the replacement time of a plurality of ion exchange cartridges included in the ion exchangers is managed by time and the ion exchange cartridges are simultaneously replaced during maintenance, a specific ion exchange cartridge is replaced before its ion exchange capacity is sufficiently used up, which is uneconomical.

The present invention has the object of solving the aforementioned problem.

A first aspect of the present disclosure is characterized by a fuel cell system comprising: a plurality of fuel cell modules each including a fuel cell stack configured to generate electric power by being supplied with oxygen-containing gas and fuel gas, and a cooling device configured to cool the fuel cell stack by allowing coolant to flow through the fuel cell stack; the cooling devices respectively included in the plurality of fuel cell modules; a coupled cooling circuit in which a plurality of cooling circuits respectively included in the plurality of cooling devices are connected in parallel to one another; and an ion exchange device connected to the coupled cooling circuit and including a plurality of ion exchangers, wherein the ion exchange device includes a switching valve configured to selectively switch a flow of coolant to the plurality of ion exchangers, and the switching valve allows coolant to flow through only one of the plurality of ion exchangers.

According to the above aspect, since the coolant flows from the plurality of fuel cell modules to only one ion exchanger, a variation in the life of the ion exchangers does not occur.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic configuration diagram of a fuel cell system according to an embodiment of the present disclosure;

FIG. 2 is a schematic configuration diagram of the fuel cell system in a state in which a coolant flows through a first ion exchanger;

FIG. 3 is a schematic configuration diagram of the fuel cell system in a state in which the coolant flows through a second ion exchanger; and

FIG. 4 is a flowchart for explaining an operation according to the embodiment.

### DETAILED DESCRIPTION OF THE INVENTION

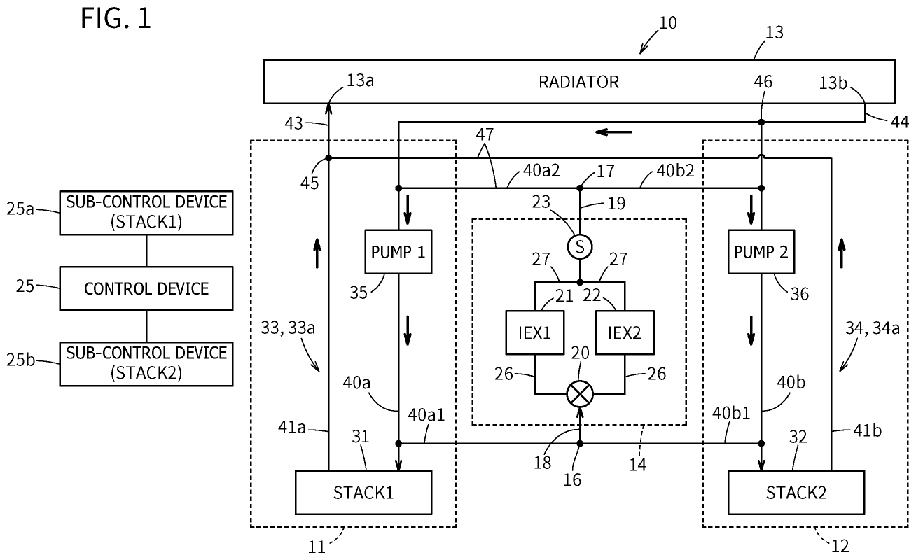

FIG. 1 is a schematic diagram showing a fuel cell system 10 according to an embodiment of the present disclosure. The fuel cell system 10 is used by being incorporated in a moving object such as a fuel cell vehicle, a ship, a submarine, an aircraft, a spacecraft, a robot, an industrial vehicle, or a forklift, or a stationary fuel cell power generation device.

The fuel cell system 10 includes, for example, a first fuel cell module 11, a second fuel cell module 12, a radiator 13, an ion exchange device 14, and a control device 25.

In the following disclosure, the fuel cell system 10 including two fuel cell modules 11 and 12 will be described, but the fuel cell system 10 may include three or more fuel cell modules.

The first fuel cell module 11 includes a first fuel cell stack 31 and a first cooling device 33, and the second fuel cell module 12 includes a second fuel cell stack 32 and a second cooling device 34. Further, each of the fuel cell modules 11 and 12 includes an oxygen-containing gas supply device, a fuel gas supply device, and an electric power extraction device (all of them are not shown).

The oxygen-containing gas supply device supplies oxygen-containing gas to the cathode of each of the fuel cell stacks 31 and 32. The oxygen-containing gas supply device includes a pump for pressurizing the oxygen-containing gas, a humidifier for humidifying the oxygen-containing gas, and the like. As the oxygen-containing gas, for example, air in the atmosphere is used.

The fuel gas supply device supplies fuel gas to the anode of each of the fuel cell stacks 31 and 32. The fuel gas supply device includes a storage tank that stores the fuel gas, an injector that injects the fuel gas toward the fuel supply pipe of each of the fuel cell stacks 31 and 32, an ejector that circulates the fuel gas, and a hydrogen circulation pump. As the fuel gas, for example, hydrogen gas is used.

The electric power extraction device includes an electric power adjustment device that adjusts electric power output by each of the fuel cell stacks 31 and 32. The electric power adjustment device includes a switching type voltage booster that boosts the output voltage of each of the fuel cell stacks 31 and 32.

Each of the first fuel cell stack 31 and the second fuel cell stack 32 is formed by stacking a plurality of unit cells of a fuel cell. The fuel cell is preferably a solid polymer electrolyte fuel cell that operates at a relatively low temperature of 80 to 95° C. However, other types of fuel cells such as a direct methanol fuel cell and an alkaline fuel cell may be used.

Each of the unit cells includes a membrane electrode assembly (MEA) in which a cathode and an anode are joined to both sides of an electrolyte membrane made of a solid polymer having an ion conductive property, and is configured by sandwiching the membrane electrode assembly between a pair of separators from both sides.

The oxygen-containing gas is supplied to the cathodes and the fuel gas is supplied to the anodes, whereby the fuel cell stacks 31 and 32 cause an electrochemical reaction to generate electric power. The electric power obtained by the power generation is used to drive, for example, an electric motor for traveling incorporated in the moving object.

A cooling flow path through which a coolant flows is formed between the unit cells adjacent to each other, and the fuel cell stacks 31 and 32 are cooled by the coolant flowing through the cooling flow paths. The coolant is preferably a mixed liquid of ethylene glycol and pure water.

In the first cooling device 33, the coolant is supplied via a coolant supply path 40a to the first fuel cell stack 31, and flows through the cooling flow path formed therein. Further, in the second cooling device 34, the coolant is supplied via a coolant supply path 40b to the second fuel cell stack 32, and flows through the cooling flow path formed therein. That is, the coolant is supplied from the cooling devices 33 and 34 to the fuel cell stacks 31 and 32 via the coolant supply paths 40a and 40b.

In the first cooling device 33, the coolant that has flowed through the first fuel cell stack 31 and has been warmed is introduced into a coolant inlet 13a of the radiator 13 via a coolant discharge path 41a and a coolant introduction path 43. Further, in the second cooling device 34, the coolant that has flowed through the second fuel cell stack 32 and has been warmed flows through a coolant discharge path 41b, and merges with the coolant flowing via the coolant discharge path 41a at a merging point 45, and the merged coolant is introduced into the coolant inlet 13a of the radiator 13 via the coolant introduction path 43. That is, the coolant is discharged from the fuel cell stacks 31 and 32 to the cooling devices 33 and 34, and then introduced into the radiator 13. The temperature of the discharged coolant is higher than the temperature of the coolant supplied to the fuel cell stacks 31 and 32.

In the present disclosure, the two fuel cell modules 11 and 12 each include one cooling device 33, 34. Note that the fuel cell modules 11 and 12 may each include two or more cooling devices.

The first cooling device 33 includes a first cooling circuit 33a and the second cooling device 34 includes a second cooling circuit 34a, and the first cooling circuit 33a and the second cooling circuit 34a are connected in parallel to each other with respect to the radiator 13 to constitute a coupled cooling circuit 47. That is, the cooling circuits 33a and 34a of the cooling devices 33 and 34 are connected to the coolant inlet 13a and a coolant outlet 13b of the common radiator 13. Further, the coolant flowing through the cooling circuit 33a and the coolant flowing through the cooling circuit 34a are mixed with each other through the common radiator 13.

The first cooling circuit 33a and the second cooling circuit 34a include the coolant supply paths 40a and 40b configured to supply the coolant to the first fuel cell stack 31 and the second fuel cell stack 32, respectively, and the coolant discharge paths 41a and 41b configured to discharge the coolant from the first fuel cell stack 31 and the second fuel cell stack 32, respectively. A first coolant pump 35 and a second coolant pump 36 are provided in the coolant supply paths 40a and 40b, respectively. It should be noted that the first coolant pump 35 and the second coolant pump 36 are not limited to being provided in the coolant supply paths 40a and 40b, respectively, as long as the first coolant pump 35 and the second coolant pump 36 are provided in the first cooling circuit 33a and the second cooling circuit 34a, respectively.

The radiator 13 performs heat exchange between the supplied warmed coolant and the atmosphere to cool the coolant. The radiator 13 includes a meandering pipe through which the coolant flows, and a large number of heat dissipation fins on the outer periphery of the pipe. The heat of the coolant is released into the atmosphere through the heat dissipation fins.

The coolant introduction path 43 is connected to the coolant inlet 13a of the radiator 13. The coolant introduction path 43 communicates with the coolant discharge paths 41b and 41b via the merging point 45. A coolant lead-out path 44 is connected to the coolant outlet 13b of the radiator 13. The coolant lead-out path 44 communicates with the coolant supply paths 40a and 40b via a branch point 46.

A bypass flow path (not shown) may be provided between the coolant inlet 13a and the coolant outlet 13b of the radiator 13. Then, by providing an on-off valve in the bypass flow path and adjusting the opening degree of the on-off valve, the flow rate of the coolant introduced from the coolant inlet 13a of the radiator 13 may be adjusted. As a result, the temperature of the coolant flowing through the coupled cooling circuit 47 can be adjusted. Instead of the on-off valve, a three way valve may be provided between the coolant introduction path 43 or the coolant lead-out path 44 and the bypass flow path. It is preferable that the opening degree of the three way valve is adjustable.

The ion exchange device 14 includes a first ion exchanger 21 (IEX1), a second ion exchanger 22 (IEX2), a switching valve 20, and a conductivity meter 23. In the present disclosure, a case where the ion exchange device 14 includes two ion exchangers 21 and 22 (a plurality of ion exchangers) will be described. Note that the ion exchange device 14 may include three or more ion exchangers.

The ion exchange device 14 including the plurality of ion exchangers 21 and 22 is connected to the coupled cooling circuit 47, and the coolant flows between the ion exchange device 14 and the coupled cooling circuit 47. It should be noted that the ion exchange device 14 is configured as a separate device independent of the fuel cell modules 11 and 12.

The first ion exchanger 21 and the second ion exchanger 22 are arranged in parallel and in close proximity to each other in the flow direction of the coolant. The first ion exchanger 21 and the second ion exchanger 22 each include an ion exchange cartridge therein. The ion exchange cartridge includes a cation exchange resin and an anion exchange resin. In the case where the ion exchanger 21, 22 adsorbs a large amount of ions and the ion removal performance decreases to be lower than a predetermined value, the ion exchange cartridge is replaced with a new one.

Even in the case where the ion exchange device 14 includes three or more ion exchangers, it is preferable that the ion exchangers are arranged in parallel and in close proximity to each other. This facilitates maintenance of the ion exchange device 14.

In the present disclosure, since the coolant flows from the two (the plurality of) fuel cell modules 11 and 12 to only one ion exchanger 21 through the coupled cooling circuit 47, the ion exchange capacity of the ion exchange cartridge of each of the ion exchangers 21 and 22 is larger (for example, twice or more) than that in the conventional case where the fuel cell modules 11 and 12 include the ion exchangers 21 and 22, respectively.

The switching valve 20 for allowing the coolant to flow through only one of the plurality of ion exchangers 21 and 22 is provided upstream of the two ion exchangers 21 and 22. The switching valve 20 has switching positions corresponding to the number of the ion exchangers. The switching valve 20 has an electromagnetic coil therein, and an electric current passes through the electromagnetic coil based on an instruction signal from the control device 25, thereby switching the flow route of the coolant.

In the case where a signal indicating that the ion exchange capacity of the ion exchanger 21, 22 is lower than a predetermined value is issued from the control device 25, the control device 25 may notify the operator of the issuance of the signal using a lamp or a display plate. The operator may manually operate the switching valve 20 based on this display.

As the switching valve 20, a rotary type or spool type three way valve or the like is used. The switching valve 20 does not allow the coolant to flow through the ion exchanger other than one of the plurality of ion exchangers 21 and 22. In other words, the switching valve 20 selects one ion exchanger through which the coolant is allowed to flow, from the plurality of ion exchangers 21 and 22. That is, the switching valve 20 selectively switches the flow of the coolant to the plurality of ion exchangers 21 and 22.

The conductivity meter 23 is provided downstream of the two ion exchangers 21 and 22. The conductivity meter 23 measures the ionic conductivity (hereinafter abbreviated as conductivity) of the coolant led out from the ion exchanger 21, 22, and transmits the measured value to the control device 25. When the performance (ion exchange capacity) of the ion exchanger 21, 22 for removing the ion components is lowered, the discharge amount of ions having conductivity from the ion exchanger 21, 22 increases, and therefore, the life of the ion exchanger 21, 22 can be determined by measuring the conductivity. It should be noted that the conductivity meter 23 may measure pH indicating the degree of acidity or alkalinity of the coolant and may use the pH instead of the conductivity value. Alternatively, a table for comparing pH and ionic conductivity may be prepared in advance, and the pH value may be converted into conductivity.

The two coolant supply path 40a and 40b branch into coolant supply branch paths 40a1 and 40b1 before reaching the fuel cell stacks 31 and 32, respectively. The coolant supply branch paths 40a1 and 40b1 merge into one inlet merging path 18 at an inlet merging point 16. The inlet merging path 18 is connected to the inlet of the switching valve 20.

The plurality of outlets of the switching valve 20 are connected to the inlets of the ion exchangers 21 and 22 via a plurality of inlet flow paths 26, respectively. The outlets of the ion exchangers 21 and 22 are joined to an outlet merging path 19 via a plurality of outlet flow paths 27, respectively. The outlet merging path 19 branches into two coolant lead-out branch paths 40a2 and 40b2 at an outlet branch point 17. The conductivity meter 23 is provided in the outlet merging path 19. The coolant lead-out branch paths 40a2 and 40b2 are connected to the coolant supply paths 40a and 40b upstream of the coolant pumps 35 and 36, respectively.

In the present disclosure, the ion exchange device 14 is used in common for the cooling devices 33 and 34 of the first fuel cell module 11 and the second fuel cell module 12. Therefore, the ion exchange device 14 can be disposed at a different location away from the plurality of fuel cell modules 11 and 12, and connected to the plurality of fuel cell modules 11 and 12 by two pipes, namely, the inlet merging path 18 and the outlet merging path 19.

As a result, the ion exchange device 14 can be disposed at a position convenient for maintenance, away from the fuel cell modules 11 and 12. Further, this is also convenient for manufacturing the ion exchange device 14 and the fuel cell modules 11 and 12 at different manufacturers and assembling them in the vehicle. Note that the maintenance includes inspection and replacement of the ion exchange cartridges housed inside the ion exchange device 14.

Since the ion exchange device 14 is not directly incorporated in the cooling circuit 33a and 34a of the fuel cell module 11 and 12, the pressure loss accompanying the circulation of the coolant in the fuel cell module 11 and 12 can be reduced.

The control device 25 is constituted by an electronic control unit (ECU). The ECU is constituted by a computer including one or more processors (CPUs), a memory, an input/output interface, and an electronic circuit. The one or more processors (CPUs) execute non-illustrated programs (computer-executable instructions) stored in the memory. The control device 25 performs all controls related to the fuel cell system 10.

A sub-control device 25a controls the fuel cell module 11 based on an instruction from the control device 25. A sub-control device 25b controls the fuel cell module 12 based on an instruction from the control device 25. Specifically, the sub-control devices 25a and 25b respectively control the supply of the reactant gases (oxygen-containing gas and fuel gas) to the fuel cell modules 11 and 12, thereby controlling electric power output from the fuel cell modules 11 and 12.

The fuel cell modules 11 and 12 are controlled independently of each other. For example, the electric power output from the fuel cell module 11 may be different from the electric power output from the fuel cell module 12. Further, the fuel cell modules may be operated at different times or stopped at different times.

The operation of the fuel cell system 10 will be described.

Based on required electric power required by the moving object, the control device 25 instructs the sub-control device 25a, 25b that controls the fuel cell module 11, 12, respectively, to output predetermined electric power at a predetermined time. The sub-control device 25a, 25b controls the oxygen-containing gas supply device, the fuel gas supply device, and the cooling device 33, 34 so that the fuel cell module 11, 12 outputs the predetermined electric power.

Since the temperature of the fuel cell stack 31, 32 rises with the power generation, the sub-control device 25a, 25b controls the coolant pump 35, 36 so that the fuel cell stack 31, 32 maintains a predetermined temperature. Specifically, as the output of the fuel cell stack 31, 32 increases, the sub-control device 25a, 25b increases the rotational speed of the coolant pump 35, 36 to increase the flow rate of the coolant discharged from the coolant pump 35, 36.

The coolant is supplied to the fuel cell stack 31, 32 via the coolant supply path 40a, 40b. The coolant that has flowed through the cooling flow path of the fuel cell stack 31, 32 and has been warmed is discharged to the coolant discharge path 41a, 41b. The discharged coolant is introduced into the coolant inlet 13a of the radiator 13 communicating with the coolant discharge path 41a, 41b, and is cooled while flowing through the pipe inside the radiator 13. The heat that is released accompanying the cooling of the coolant is released into the atmosphere through the heat dissipation fins.

The coolant branched from the coolant supply path 40a and flowing through the coolant supply branch path 40a1 and the coolant branched from the coolant supply path 40b and flowing through the coolant supply branch path 40b1 merge in one inlet merging path 18. Thereafter, the coolant flows through only one of the two ion exchangers 21 and 22 via the switching valve 20. In the process of passing through one ion exchanger, ion components (cations and anions) are removed. In a state where the coolant is flowing through one of the two ion exchangers 21 and 22, it is possible to perform maintenance on the other ion exchanger through which the coolant is not flowing. Therefore, since it is not necessary to stop the flow of the coolant flowing through one ion exchanger, the operating rate of the fuel cell system 10 is improved.

The conductivity of the coolant discharged from the ion exchanger 21, 22 is measured by the conductivity meter 23 provided in the outlet merging path 19. The coolant whose conductivity has been measured passes through the outlet branch point 17 and flows through the two coolant lead-out branch paths 40a2 and 40b2. The coolant that has flowed through the coolant lead-out branch paths 40a2 and 40b2 is led out to the upstream side of the coolant pumps 35 and 36 of the coolant supply paths 40a and 40b.

### [Flowchart of Fuel Cell System]

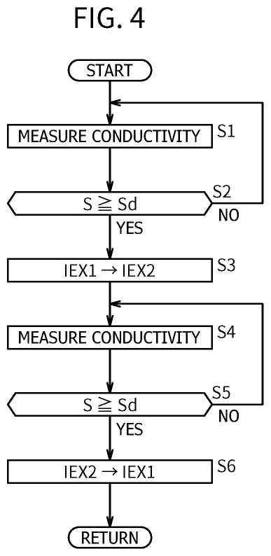

The operation procedure of the fuel cell system 10 according to the embodiment will be described with reference to the flowchart shown in FIG. 4.

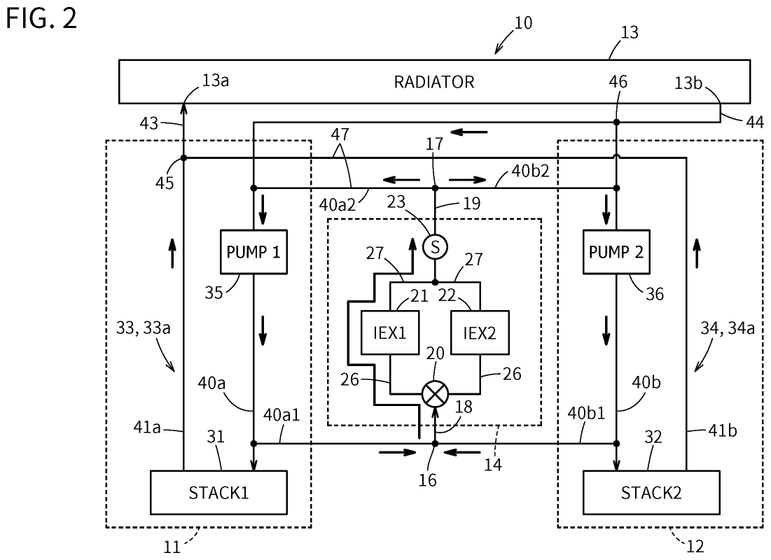

In step S1, in a state where the coolant is flowing through the first ion exchanger 21 (IEX1) as indicated by the arrow in FIG. 2, the control device 25 measures the conductivity of the coolant based on a signal output from the conductivity meter 23.

In step S2, the control device 25 determines whether or not the conductivity S measured by the conductivity meter 23 is greater than a predetermined value Sd (an upper limit value of conductivity) set in advance. Then, in the case where the determination result is affirmative (step S2: YES), the control device 25 advances the process to step S3. At this time, by using a lamp or a display plate, the control device 25 may notify the operator that the ion exchanger 21 needs to be switched. In the case where the determination result is negative (step S2: NO), the control device 25 returns the process to step S1. Here, the predetermined value Sd is determined based on an allowable value of the electric current flowing via the coolant. When an electric current exceeding the allowable value flows via the coolant, there is a possibility that the power generation efficiency of the fuel cell stack 31, 32 may be lowered or the safety may be lowered due to liquid junction.

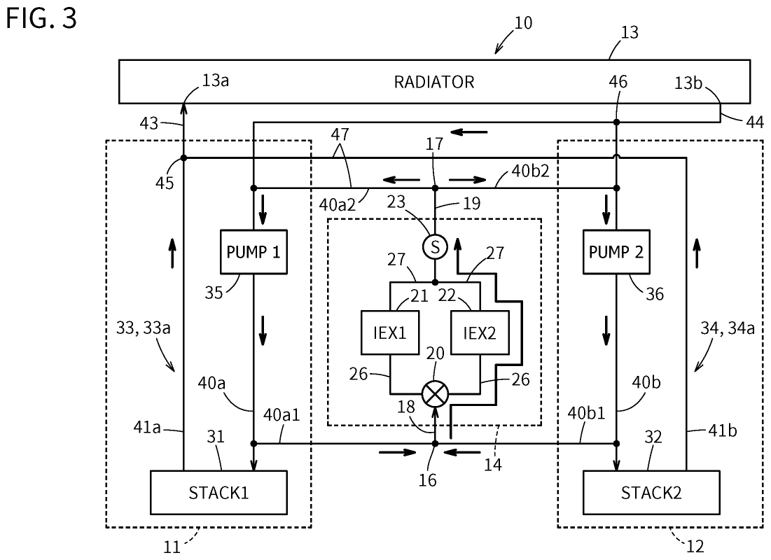

In step S3, the control device 25 instructs switching from the first ion exchanger 21 (IEX1) to the second ion exchanger 22 (IEX2). Specifically, the control device 25 instructs the switching valve 20 to change the flow of the coolant so that the coolant that has been flowing through the first ion exchanger 21 (IEX1) as indicated by the arrow in FIG. 2 flows through the second ion exchanger 22 (IEX2) as indicated by the arrow in FIG. 3. Note that, in the case where the lamp or the display plate indicates that the switching is necessary, the operator may manually operate the switching valve 20.

In step S4, in a state where the coolant is flowing through the second ion exchanger 22 (IEX2), the control device 25 measures the conductivity of the coolant based on the signal output from the conductivity meter 23.

In step S5, the control device 25 determines whether or not the conductivity S measured by the conductivity meter 23 is greater than a predetermined value Sd (an upper limit value of conductivity) set in advance. Then, in the case where the determination result is affirmative (step S5: YES), the control device 25 advances the process to step S6. At this time, by using a lamp or a display plate, the control device 25 may notify the operator that the ion exchanger 22 needs to be switched. In the case where the determination result is negative (step S5: NO), the control device 25 returns the process to step S4. Here, the predetermined value Sd is determined based on an allowable value of the electric current flowing via the coolant. Note that the predetermined value Sd in step S5 may be the same as or different from the predetermined value Sd in step S2. Further, the predetermined value Sd may be changed for each of the ion exchangers 21 and 22 according to the specifications of the ion exchangers 21 and 22. Furthermore, the predetermined value Sd may be changed depending on the operating conditions (outside air temperature, output conditions) of the fuel cell stacks 31 and 32 mounted in the fuel cell modules 11 and 12 of the present disclosure.

In step S6, the control device 25 instructs switching from the second ion exchanger 22 to the first ion exchanger 21. Specifically, the control device 25 instructs the switching valve 20 to change the flow of the coolant so that the coolant that has been flowing through the second ion exchanger 22 as indicated by the arrow in FIG. 3 flows through the first ion exchanger 21 as indicated by the arrow in FIG. 2. Note that, in the case where the lamp or the display plate indicates that the switching is necessary, the operator may manually operate the switching valve 20.

The following notes are further disclosed in relation to the above-described embodiment.

### Supplementary Note 1

The fuel cell system (10) includes the plurality of fuel cell modules (11, 12) each including the fuel cell stack (31, 32) configured to generate electric power by being supplied with oxygen-containing gas and fuel gas, and the cooling device (33, 34) configured to cool the fuel cell stack by allowing coolant to flow through the fuel cell stack, the fuel cell system including: the cooling devices respectively included in the plurality of fuel cell modules; the coupled cooling circuit (47) in which the plurality of cooling circuits (33a, 34a) respectively included in the plurality of cooling devices are connected in parallel to one another; and the ion exchange device (14) connected to the coupled cooling circuit and including the plurality of ion exchangers (21, 22), wherein the ion exchange device includes the switching valve (20) configured to selectively switch a flow of the coolant to the plurality of ion exchangers, and the switching valve allows the coolant to flow through only one of the plurality of ion exchangers.

According to this configuration, since the coolant flows through only one ion exchanger, the ion exchanger can be used to its ion adsorption limit without causing a variation in the life unlike in the case of the fuel cell system in which the coolant flows through a plurality of ion exchangers. Further, since the life of the ion exchanger is affected by the temperature of the coolant, the ion exchanger through which the coolant does not flow can be kept in a sound state.

### Supplementary Note 2

In the fuel cell system according to Supplementary Note 1, the cooling circuits may each include the coolant supply path (40a, 40b) configured to supply the coolant to the fuel cell stack, and the plurality of coolant supply paths respectively included in the plurality of fuel cell modules may merge together to form one inlet merging path (18) configured to communicate with the switching valve.

According to this configuration, the switching valve can allow the entire coolant contained in the coupled cooling circuit to flow through one ion exchanger via the inlet merging path.

### Supplementary Note 3

In the fuel cell system according to Supplementary Note 2, the plurality of outlets of the switching valve may communicate with the inlets of the plurality of ion exchangers via the plurality of inlet flow paths (26), respectively.

According to this configuration, the coolant can be allowed to selectively flow to the inlet of any one of the plurality of ion exchangers by the switching valve.

### Supplementary Note 4

In the fuel cell system according to Supplementary Note 3, the outlets of the plurality of ion exchangers may be joined together via the respective outlet flow paths (27) and communicate with one outlet merging path (19).

According to this configuration, the coolant that is allowed to selectively flow by the switching valve can be guided from one of the plurality of ion exchangers to one outlet merging path.

### Supplementary Note 5

In the fuel cell system according to Supplementary Note 4, the outlet merging path may be provided with the conductivity meter (23) configured to measure the conductivity(S) of the coolant.

According to this configuration, the adsorption limit of the ion exchanger can be confirmed by the measured conductivity value. Further, since the entire coolant flows through the outlet merging path, it is not necessary to provide a conductivity meter in each fuel cell module.

### Supplementary Note 6

In the fuel cell system according to Supplementary Note 4, the coolant supply paths may each include the coolant pump (35, 36) configured to supply the coolant to the fuel cell stack, and each of the plurality of coolant lead-out branch paths (40a2, 40b2) into which the outlet merging path branches may communicate with the upstream side of the coolant pump included in each of the fuel cell modules.

According to this configuration, an optimal amount of coolant can be allowed to flow from each coolant pump depending on the power generation conditions of each fuel cell module.

Although the present disclosure has been described in detail, the present disclosure is not limited to the above-described individual embodiments. Various additions, replacements, modifications, partial deletions, and the like can be made to these embodiments without departing from the essence and gist of the present disclosure, or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A fuel cell system comprising:
a plurality of fuel cell modules each including a fuel cell stack configured to generate electric power by being supplied with oxygen-containing gas and fuel gas, and a cooling device configured to cool the fuel cell stack by allowing coolant to flow through the fuel cell stack;
the cooling devices respectively included in the plurality of fuel cell modules;
a coupled cooling circuit in which a plurality of cooling circuits respectively included in the plurality of cooling devices are connected in parallel to one another; and
an ion exchange device connected to the coupled cooling circuit and including a plurality of ion exchangers,
wherein the ion exchange device includes a switching valve configured to selectively switch a flow of coolant to the plurality of ion exchangers, and the switching valve allows coolant to flow through only one of the plurality of ion exchangers.

2. The fuel cell system according to claim 1, wherein
the cooling circuits each include a coolant supply path configured to supply coolant to the fuel cell stack, and
a plurality of the coolant supply paths respectively included in the plurality of fuel cell modules merge together to form one inlet merging path configured to communicate with the switching valve.

3. The fuel cell system according to claim 2, wherein
a plurality of outlets of the switching valve communicate with inlets of the plurality of ion exchangers via a plurality of inlet flow paths, respectively.

4. The fuel cell system according to claim 3, wherein
outlets of the plurality of ion exchangers are joined together via respective outlet flow paths and communicate with one outlet merging path.

5. The fuel cell system according to claim 4, wherein
the outlet merging path is provided with a conductivity meter configured to measure conductivity of coolant.

6. The fuel cell system according to claim 4, wherein
the coolant supply paths each include a coolant pump configured to supply coolant to the fuel cell stack, and
each of a plurality of coolant lead-out branch paths into which the outlet merging path branches communicates with an upstream side of the coolant pump included in each of the fuel cell modules.

7. The fuel cell system according to claim 5, further comprising a control device, wherein
in a case where the conductivity measured by the conductivity meter is greater than a predetermined value set in advance, the control device displays that any of the ion exchangers needs to be switched by operating the switching valve.
